(19) United States
(12) Patent Application Publication
(10) Pub. No.: US 2009/0300061 A1
(43) Pub. Date: Dec. 3, 2009

(54) System and method for universe generation

(75) Inventors: Bhanu Prashanthi Murthy, Bangalore (IN); Farhana Khan, Borivali West (IN)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Infosys Technologies Ltd., Bangalore (IN)

(21) Appl. No.: 12/315,499

(22) Filed: Dec. 3, 2008

(30) Foreign Application Priority Data
Dec. 3, 2007 (IN) 2867/CHE/2007

(51) Int. Cl. G06F 17/30

(52) U.S. Cl. 707/103 R; 707/E17.055

(57) ABSTRACT

A system and method for automatically generating the universe from the documented MS-Excel file is disclosed. The methods for the Generate Universe, Migrate Universe, Update Universe and Document Universe are disclosed. The method helps in reduction of build effort of the project and removes the problem of corruption of the universe file of link being lost. The method provides easy maintenance of the universe versions and multi-user development environments and updating of universe files.

### BACKGROUND OF THE INVENTION

The invention relates generally to automatic creation of universe from the documented design which is in MS-Excel document. In addition, the present technique documents the universe details on an MS-Excel format.

The Universe is a semantic layer in a Business Objects which hides the end user from the complexities of the databases. Moreover, it's a business representation of the databases.

Application of a Universe can be in Reporting Tools, or in Trend Analysis or for preparing dash board reports.

Currently the universe can be created using the Designer Tool of the Business Object. However if multiple users have to code the universe this is a tedious job.

The limitation was that only one person can work on the universe version. If multiple users had to work then the issue was reconciliation was a big problem as multiple copies of universe file had to be merged into one. There have been several cases where a large amount of effort has been spent for reconciliation as manual reconciliation needs time.

Also there was significant effort spent in document the universe under design and an equivalent or more effort was spent on converting the same design into a universe.

The time spent on the design activities for business objects is significant and equal amount of time is spent on building the same. Most times the effort is much more due to the complexity and rework involved in the same.

To offer a quality solution, the effort spent on reviews and testing is significant. There have been scenarios where even though the change to the code is insignificant, since the changes are done manually, verification and validation of the whole package needs to be done thus increasing the cost of quality. There have been several cases where a large amount of effort has been spent for reconciliation as manual reconciliation needs time. Incase of migration equal effort is spent on build again

In case of migration there is a huge amount of effort involved to validate the migration process even though migration is achieved by a Tool.

Therefore there is need for an improved method for automatic generation of a universe from the documented design which is in MS-Excel document and which would remove manual intervention as much as possible.

### BRIEF SUMMARY OF THE INVENTION

A method for automatically generating at least one universe using a computer system is disclosed. The method includes documenting multiple universe files in MS-Excel and generating the at least one universe from the documented MS-Excel files. The inventive method also includes updating of universe and migration of universe.

The present invention satisfies the above-identified needs, as well as other by providing a Tool which comprising of four major options: Generate Universe, Migrate Universe, Update Universe and Document Universe. This Tool is based on the inventive method as disclosed. This Tool would remove manual intervention as much as possible in generating and migrating and updating the universe. Tool also gives the user the flexibility to convert the design into coding, perform Universe migration, document a Universe and revert back to an earlier version of the Universe—all in one click. The prerequisites to run the Tool are: Bo main key for 5.X version of business objects, CMC setup for XIr2 version of business objects, BO Client installation on Windows Machine, and Microsoft Excel. Currently the Tool can be run on windows client. Following are the features that are supported by the Tool:
Generating the universe
Documenting the universe back from the repository
Update the versions
Migrating Universes between Business Objects versions

Other objects, features, and advantages will be apparent to persons of ordinary skill in the art from the following detailed description of the invention and the accompanying drawings.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a block diagram of the Tool depicting the overview of the Business Object in one embodiment of the present technique;

FIG. 2A is a flowchart depicting a method for generating a Universe from an MS-Excel file, in one embodiment of the present technique;

FIG. 2B is a flowchart depicting a method for generating a Universe from an MS-Excel file, in one embodiment of the present technique;

FIG. 3 is a flowchart depicting a method for Universe documentation, in one embodiment of the present technique;

FIG. 4A is a flowchart depicting a method for Universe migration, in one embodiment of the present technique;

FIG. 4B is a flowchart depicting a method for Universe migration, in one embodiment of the present technique;

FIG. 5 is a flowchart depicting a method for updating a Universe, in one embodiment of the present technique;

FIG. 6 is a screen-shot of on load of the Tool, in one embodiment of the present technique;

FIG. 7 is a screen-shot of on click of Generate Universe button in the Tool, in one embodiment of the present technique;

FIG. 8 is a screen-shot of user identification and authentication when the version selected is 5x, in the Tool, in one embodiment of the present technique;

FIG. 9 is a screen-shot of user identification and authentication when the version selected is XIr2, the CMS Logon Screen, in the Tool, in one embodiment of the present technique;

FIG. 10 is a screen-shot of on click of Document Universe button in the Tool, in one embodiment of the present technique;

FIG. 11 is a screen-shot of on click of Migrate Universe button in the Tool, in one embodiment of the present technique;

FIG. 12 is a screen-shot of on click of Update Universe button in the Tool, in one embodiment of the present technique; and

FIG. 13 is a system illustrating a generalized computer network arrangement, in one embodiment of the present technique.

### DETAILED DESCRIPTION

The following description is full and informative description of the best method and system presently contemplated for carrying out the present invention which is known to the inventors at the time of filing the patent application. Of course, many modifications and adaptations will be apparent to those skilled in the relevant arts in view of the following description in view of the accompanying drawings and the appended claims. While the system and method described herein are provided with a certain degree of specificity, the present technique may be implemented with either greater or lesser specificity, depending on the needs of the user. Further, some of the features of the present technique may be used to advantage without the corresponding use of other features described in the following paragraphs. As such, the present description should be considered as merely illustrative of the principles of the present technique and not in limitation thereof, since the present technique is defined solely by the claims.

As a preliminary matter, the definition of the term “or” for the purpose of the following discussion and the appended claims is intended to be an inclusive “or” That is, the term “or” is not intended to differentiate between two mutually exclusive alternatives. Rather, the term “or” when employed as a conjunction between two elements is defined as including one element by itself, the other element itself, and combinations and permutations of the elements. For example, a discussion or recitation employing the terminology “A” or “B” includes: “A” by itself, “B” by itself and any combination thereof, such as “AB” and/or “BA.” It is worth noting that the present discussion relates to exemplary embodiments, and the appended claims should not be limited to the embodiments discussed herein.

The invention relates generally to automatic creation of universe from the documented design which is in MS-Excel document. In addition, the technique documents the universe details on an MS-Excel format.

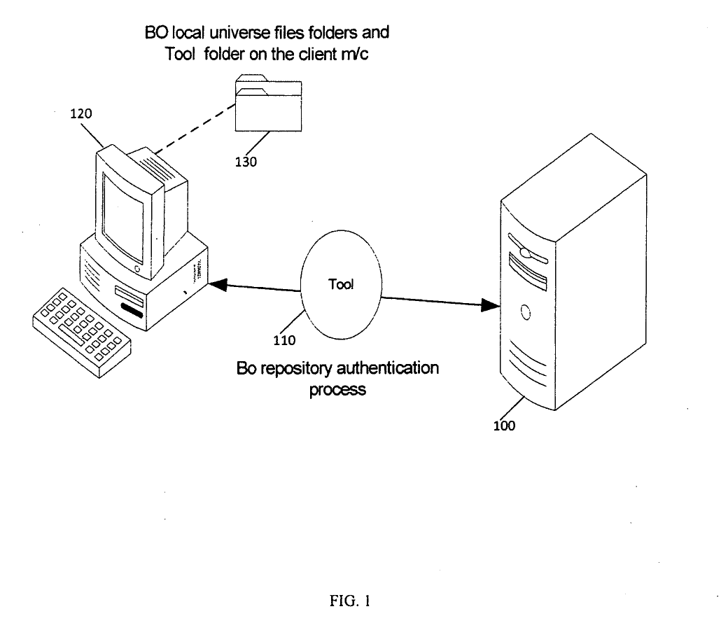

Referring to figures, FIG. 1 is a block diagrams of the proposed the Tool and Business Object (BO). In one embodiment of the present technique, the Tool 110 that resides in a client 120 interacts with a BO server 100. In addition, the Tool 110 is a client process that uses various library files installed on the client 120. Moreover, the Tool may be used to connect to the server 100 for authenticating information.

In an embodiment of the present technique, the client 120 may be a computer system that accesses a (remote) service on another computer by some kind of network. In particularity, the term was first applied to devices that were not capable of running their own stand-alone programs, but could interact with remote computers via a network. Additionally, these dumb terminals were clients of the time-sharing mainframe computer.

In an embodiment of the present technique, the client-server model is still used today on the internet, where a user may connect to a service operating on a remote system through the internet protocol suite. Moreover, web browsers are clients 120 that connect to web servers 100 and retrieve web pages for display. Most people use e-mail clients to retrieve their e-mail from their internet service provider's mail storage servers. In addition, online chat uses a variety of clients, which vary depending on the chat protocol being used.

In an embodiment of the present technique, increasingly, existing large client applications are being switched to websites, making the browser a sort of universal client. In contrary, this avoids the hassle of downloading a large piece of software onto any computer you want to use the application on. By way of example, one such may be web mail.

In one embodiment of the present technique, the client 120 may be focusing on two functions herein:
BO local universe file folders 130 and
Tool folder 130 on the client machine 120.

Furthermore, the Tool 110 checks for the BO repository authentication process on server 100.

In an embodiment of the present technique, a method for automatically generating at least one universe using a computer system is disclosed. The inventive method comprising: documenting a plurality of universe files in MS-Excel; and generating the at least one universe from the documented MS-Excel files. Documenting Universe function is briefly described below.

In an embodiment of the present invention, method for documenting the universe into MS-Excel file is disclosed. In this phase following steps are there. Designer Application, Universe and MS-Excel are defined at a global level. User is allowed to select the version of the Business objects he is using. Once the value has been populated in drop down menu, the browse button is activated. On click of browse; the user can log on to designer and select the universe file he wants to Document. Document Universe button is enabled at the end of this process. In document universe; following sub routines are called:
a. ListLinkedUniverse : Lists all the linked universes
b. ListUnivParameters: Lists the Universe connection parameters
c. ListTables: Lists all the tables that are in use in the Universe file selected
d. ListColumns: Lists all the columns of the above tables.
e. ListJoins: Lists all the joins define for the tables documented above
f. ListContexts: Lists all the available contexts defined for the Universe file selected.
g. ListClasses: Lists all the classes that have been defined in the Universe file that has been selected
h. ListObjects: Lists all the objects belonging to the classes documented above
i. ListConditions: Lists all the conditions
j. ListIncompatibility: Lists the incompatibility between the different tables and objects of the Universe file selected.

On completion of the above subroutines, the universe file is closed and the documented universe is available for use.

In another embodiment of the present invention, method for generating the Universe from documented universe is disclosed. In this phase following steps are there. Designer Application and Universe are defined at a global level. When the user clicks on browse button; it throws open a dialog box for selecting an excel file from which the Universe has to be generated. At the end of this process; the version selection button is enabled. As soon as the user selects a version; the dialog box for logging into designer of the appropriate version is thrown up. This is for credential checking. A blank universe will be opened first. Generate Universe button will be enabled at the end of this process. On click of Generate Universe; the following subroutines will be called:
a. AddUnivParameters: Adds universe descriptions to the new universe file created.
b. AddTables: Adds the tables from the excel file onto the new Universe file.
c. AddColumns: Adds columns to the above added tabled from the excel file.
d. AddJoins: Adds joins between the tables from the excel file.
e. AddContexts: Adds contexts to the universe file.
f. AddClasses: Adds classes to the universe file.
g. AddObjects: Adds objects to the universe
h. AddIncompatibility: Add incompatibility between the tables and objects from the excel file selected
i. AddConditions: Adds conditions to the universe file.

On completion of the above subroutines, the excel file is closed and the cursor is passed to the Designer where the new universe file sits. The user is prompted to save the Universe. And at the end, Universe is available which is generated from the documented excel files.

In yet another embodiment of the present invention, method for updating of the universe is disclosed. In this phase following steps are there. Designer Application, Universe and MS-Excel are defined at a global level. Only the version selection is active at this point. As soon as the user selects a version, appropriate dialog box for designer log in prompts the user to log in to designer.

Once the user is validated on Designer; the browse button gets enabled. The user can now select the MS-Excel file where he wants to download the Universe so he can make modifications. At the end of this process, Get Info button is enabled. The user then clicks on Get Info; to document the universe that he has selected.

Once the documentation is complete; user can open the MS-Excel file and make the necessary modifications. Only some cells are allowed to be modified like the objects description. The object name itself cannot be modified and the cell will be locked to prevent the user from doing the same

Once the modifications are complete; the user can click on Update universe to bulk update all the modifications that he has made on the excel file. A new Universe file will be created and the user will be prompted to save the same.

The inventive method is implemented in the Tool which is used to perform the different operations like universe generation, universe documentation, and universe updating and universe migration as discussed below.

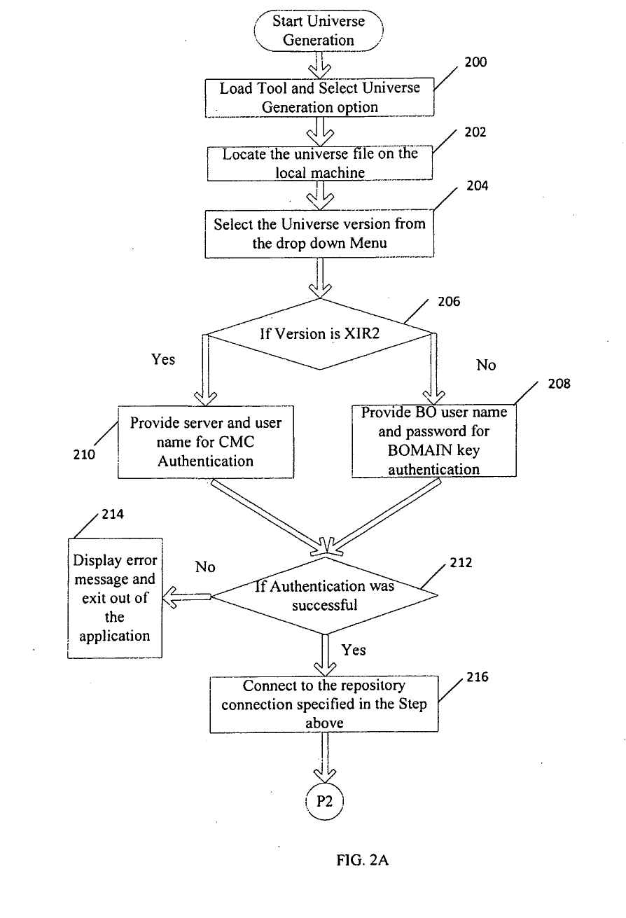

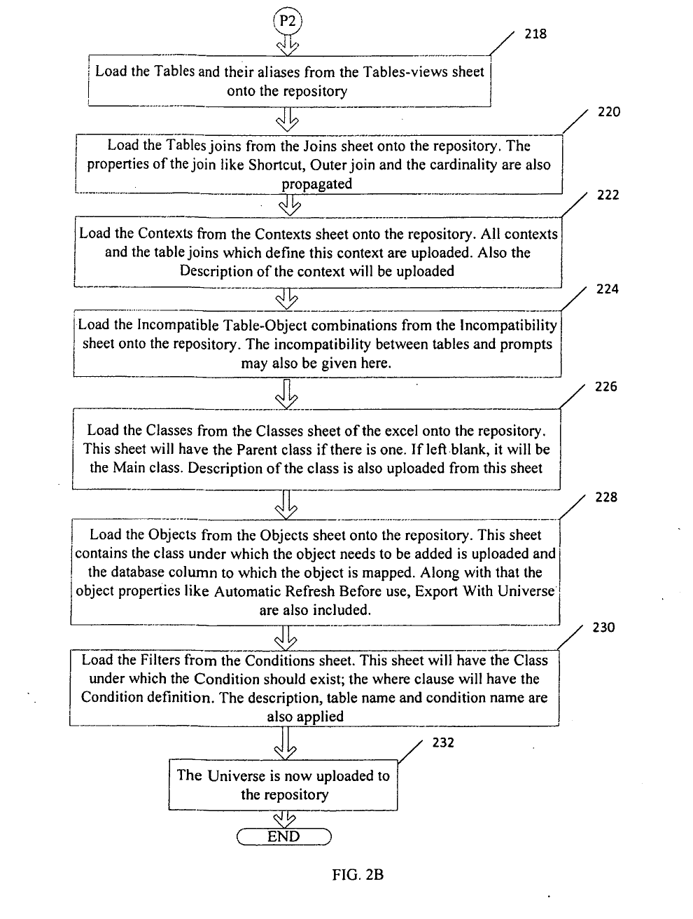

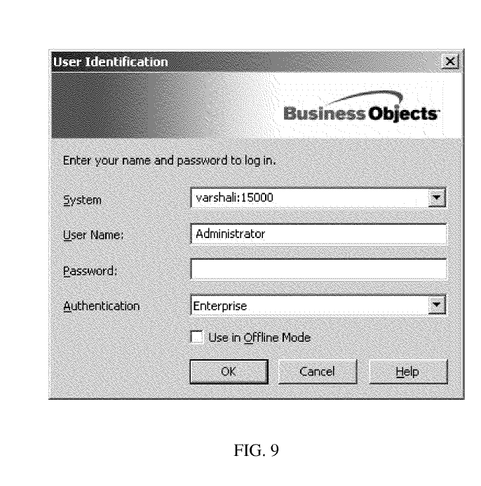

Referring to the FIG. 2A, which is flowchart depicting a method for generating a Universe from an MS-Excel file, in one embodiment of the present technique. The method starts in step 200, wherein, the Tool is loaded is loaded and Universe Generation option is selected from the available one. In step 202, a universe file on the local machine is located and universe version is selected from the drop down menu as described in step 204. In step 206, version is checked against XIR2. If the version is XIR2, then CMC authentication screen is shown as depicted in FIG. 9 and username and server details are provided for authentication 210. If the version is not XIR2, then BO user name and password are required for BOMAIN key authentication, as described in step 208.

If the authentication is not successful, then error message is displayed and application is exited 214. If authentication is successful 212, then in step 216 connect to the repository connection as specified in step 202.

Referring to the FIG. 2B, which is a flowchart depicting a method for generating a Universe from an MS-Excel file, in one embodiment of the present technique. In step 218, Load the Tables and their aliases from the Tables-views sheet onto the repository. In step 220, Load the Tables joins from the Joins sheet onto the repository. The properties of the join like Shortcut, Outer join and the cardinality are also propagated. In step 222, Load the Contexts from the Contexts sheet onto the repository. All contexts and the table joins which define this context are uploaded. The Description of the context will be uploaded. In step 224, Load the Incompatible Table-Object combinations from the Incompatibility sheet onto the repository. The incompatibility between tables and prompts may also be given here. In step 226, Load the Classes from the Classes sheet of the MS-Excel onto the repository. This sheet will have the Parent class if there is one. If left blank, it will be the Main class. Description of the class is also uploaded from this sheet. In step 228, Load the Objects from the Objects sheet onto the repository. This sheet contains the class under which the object needs to be added is uploaded and the database column to which the object is mapped. Along with that the object properties like Automatic Refresh Before use, Export with Universe are also included. In step 230, Load the Filters from the Conditions sheet. This sheet will have the Class under which the Condition should exist; the where clause will have the Condition definition. The description, table name and condition name are also applied. In step 232, the Universe is now uploaded to the repository. Thus at the end of this method, universe is generated and available in the repository.

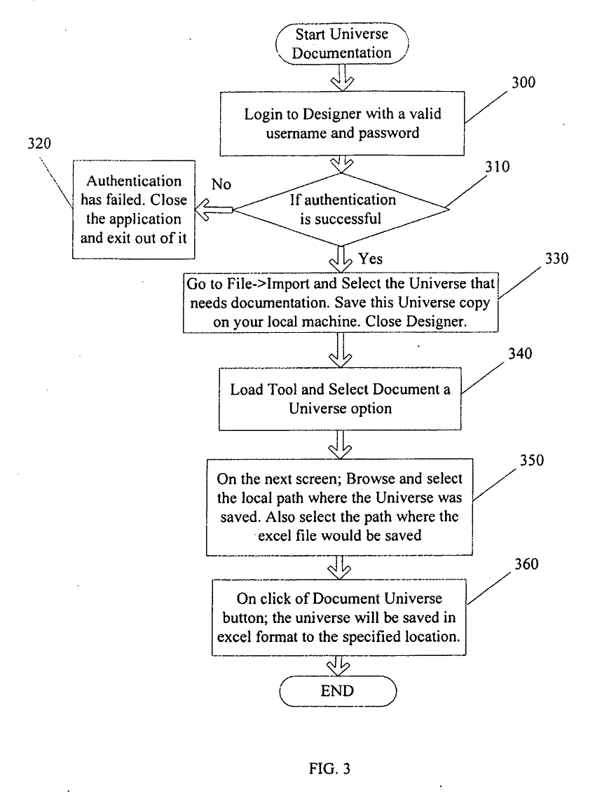

Referring to the FIG. 3, which is flowchart depicting a method for Universe documentation, in one embodiment of the present technique. The method starts in step 300, wherein, Login to Designer with a valid username and password. If user authentication is failed then close the application and exit 320. If user authentication is successful 310 then go to step 330.

In step 330, Go to File->Import and Select the Universe that needs documentation. Save this Universe copy on your local machine and Close Designer. In step 340, Load the Tool and Select Document a Universe option. On the next screen; Browse and select the local path where the Universe was saved. And also select the path where the excel file would be saved 350. In step 360 on click of Document Universe button; the universe will be saved in MS-Excel format to the specified location.

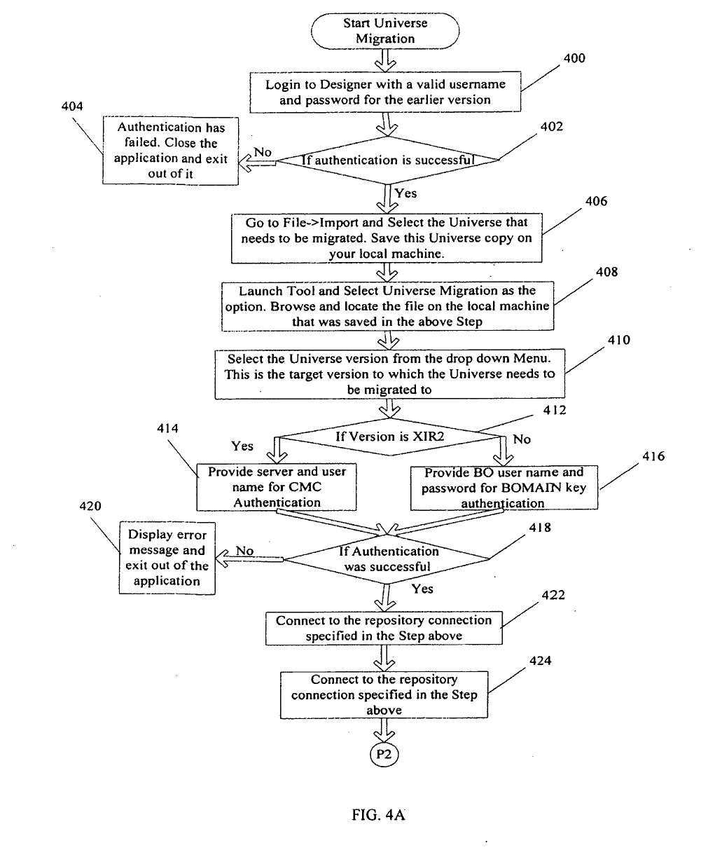

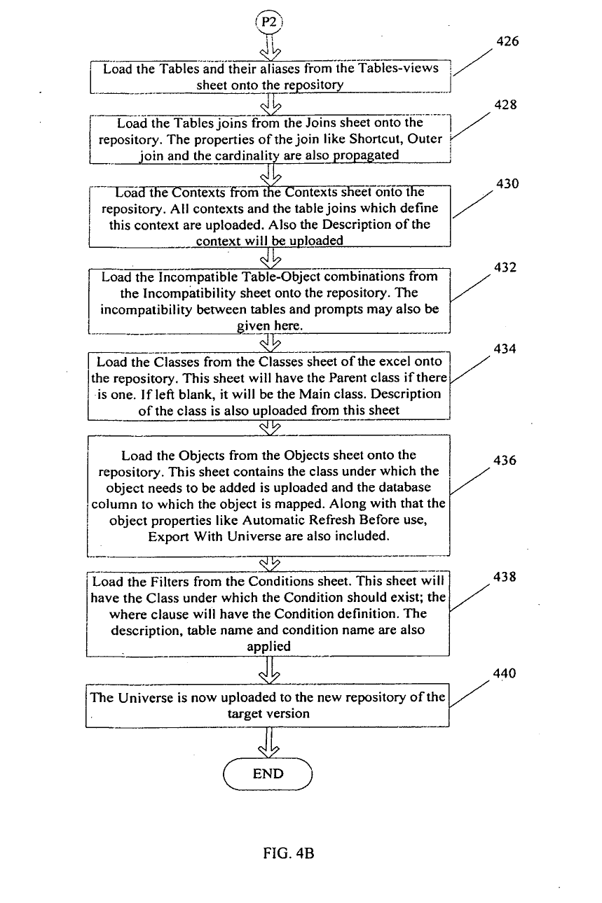

Referring to FIG. 4A which is a flowchart depicting a method for Universe migration, in one embodiment of the present technique. The method starts in step 400, wherein, Login to Designer with a valid username and password. If user authentication is failed then close the application and exit 404. If user authentication is successful 402 then go to step 406.

In step 406, Go to File->Import and Select the Universe that needs to be migrated. Save this Universe copy on your local machine. In next step 408, Launch the Tool and Select Universe Migration as the option. Browse and locate the file on the local machine that was saved in the above Step 406. In step 410, Select the Universe version from the drop down Menu. This is the target version to which the Universe needs to be migrated to. In step 412, version is checked against XIR2. If the version is XIR2, then CMC authentication screen is shown as depicted in FIG. 9 and username and server details are provided for authentication 414. If the version is not XIR2, then BO user name and password are required for BOMAIN key authentication, as described in step 416.

If the authentication is not successful, then error message is displayed and application is closed and exited 420. If authentication is successful 418, then in step 422 then connect to the repository connection as specified in step 408 as described in step 424.

Referring to FIG. 4B which is a flowchart depicting a method for Universe migration, in one embodiment of the present technique. In step 426, Load the Tables and their aliases from the Tables-views sheet onto the repository. In step 428, Load the Tables joins from the Joins sheet onto the repository. The properties of the join like Shortcut, Outer join and the cardinality are also propagated. In step 430, Load the Contexts from the Contexts sheet onto the repository. All contexts and the table joins which define this context are uploaded. Also the Description of the context will be uploaded. In step 432, Load the Incompatible Table-Object combinations from the Incompatibility sheet onto the repository. The incompatibility between tables and prompts may also be given here. In step 434, Load the Classes from the Classes sheet of the MS-Excel onto the repository. This sheet will have the Parent class if there is one. If left blank, it will be the Main class. Description of the class is also uploaded from this sheet. In step 436, Load the Objects from the Objects sheet onto the repository. This sheet contains the class under which the object needs to be added is uploaded and the database column to which the object is mapped. Along with that the object properties like Automatic Refresh Before use, Export with Universe are also included. In step 438, Load the Filters from the Conditions sheet. This sheet will have the Class under which the Condition should exist; the where clause will have the Condition definition. The description, table name and condition name are also applied. In step 440, the Universe is now uploaded to the new repository of the target version and hence the Universe Migration is done. It is to be noted that Universe Migration does the same function as Universe Documentation followed by Universe Generation.

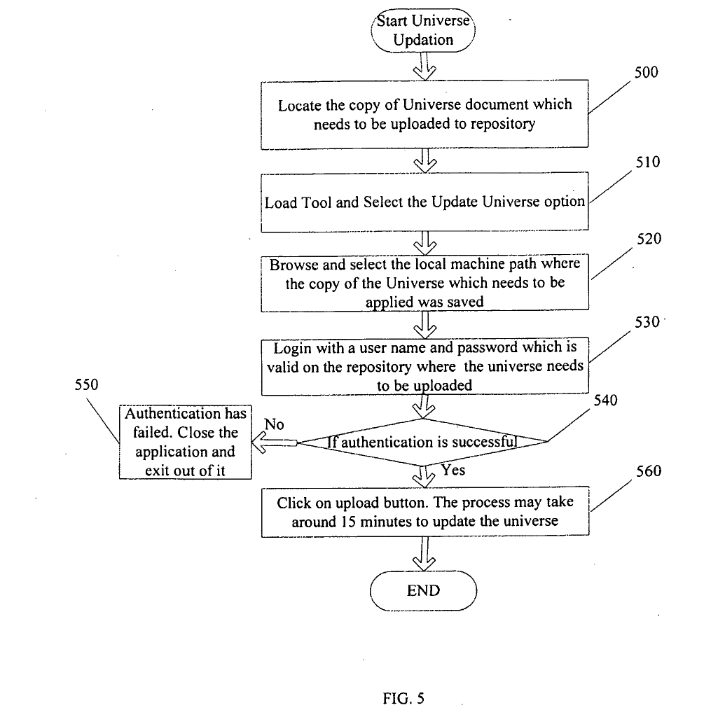

Referring to FIG. 5 which is a flowchart depicting a method for updating a Universe, in one embodiment of the present technique. The method starts in step 500, wherein, Locate the copy of Universe document which needs to be uploaded to repository. In next step 510, Load the Tool and Select the Update Universe option from the available one. In step 520, Browse and select the local machine path where the copy of the Universe which needs to be applied was saved. In step 530, Login with a user name and password which is valid on the repository where the universe needs to be uploaded. If the authentication is successful 540 then click on upload button. The process may take around 15 minutes to update the universe 560. If user authentication fails then application is closed and exit 550. It is to be noted that for Universe Update it is required to have the copy of the Universe which needs to be applied already present either in MS-Excel or .unv file format. If the .unv file is only available, user may use Universe Documentation and create the MS-Excel file. Update can be classified as the same as Universe Generation.

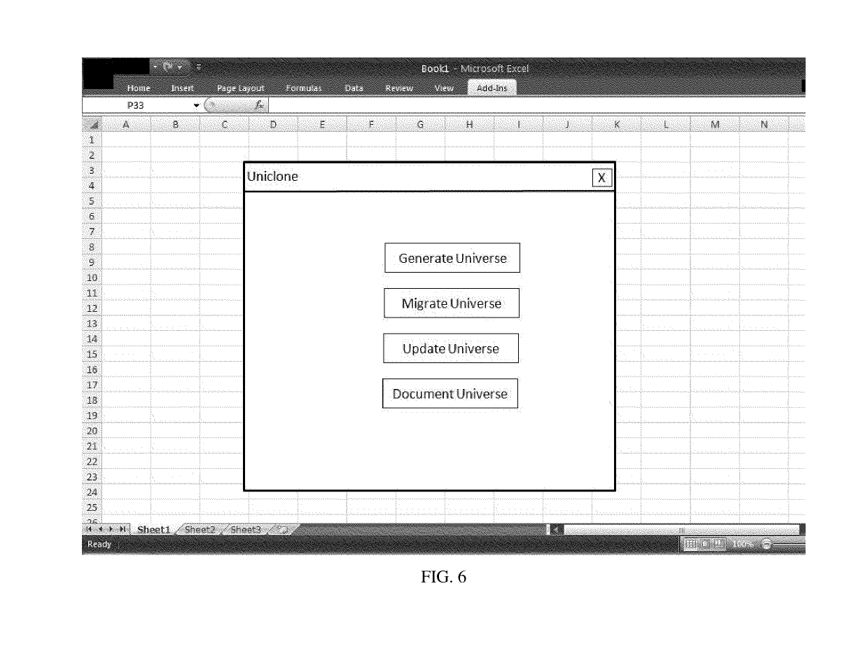

Referring to FIG. 6 which is a screen-shot of on load of the Tool, in one embodiment of the present technique. The screen would look like as shown in FIG. 6 when the proposed Tool is loaded which is based on the inventive method as disclosed in one embodiment of the present technique.

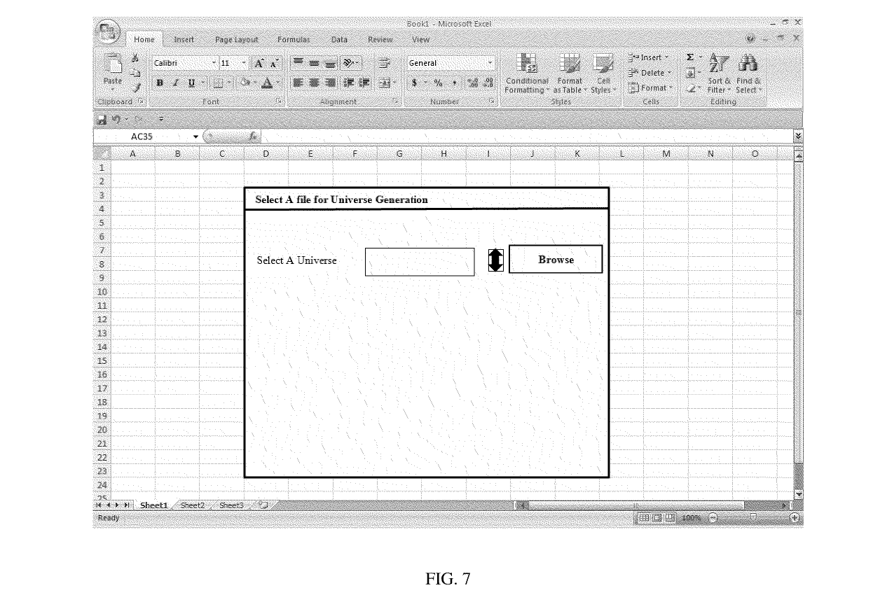

Referring to FIG. 7 which is a screen-shot of on click of Generate Universe button in the Tool, in one embodiment of the present technique. The above screen will be displayed when the user click on the generate universe button as available in the Tool as shown in FIG. 6.

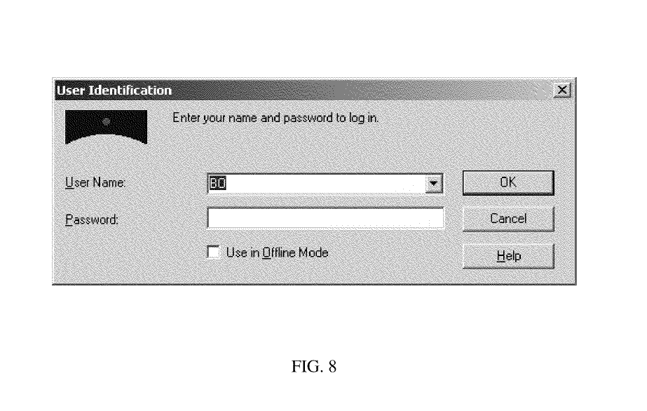

Referring to FIG. 8 which is a screen-shot of user identification and authentication when the version selected is 5x, in the Tool, in one embodiment of the present technique. When user selects the version as 5x that is other that XIR2 then the given authentication screen would be dispayed.

Referring to FIG. 9 which is a screen-shot of user identification and authentication when the version selected is XIR2, the CMS Logon Screen, in the Tool, in one embodiment of the present technique. The above log on screen will be displayed to the user when the version selected is XIR2.

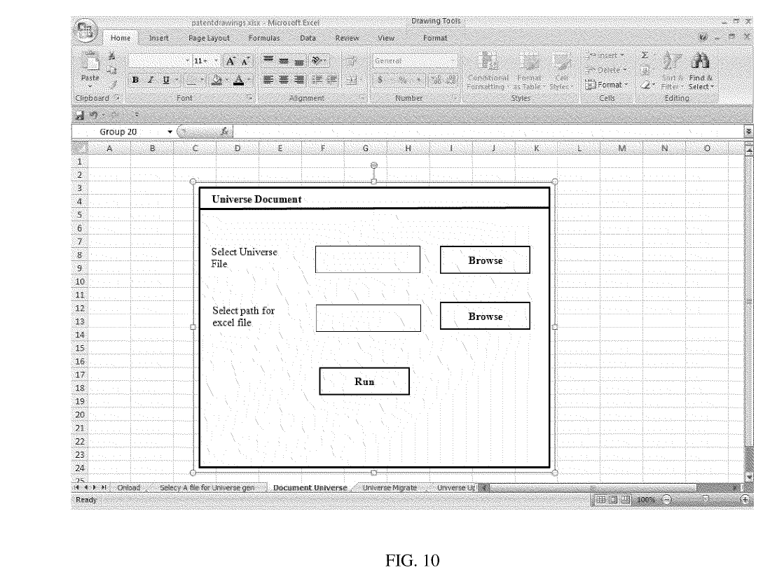

Referring to FIG. 10 which shows a screen-shot when user clicks on Document Universe button in the Tool, in one embodiment of the present technique.

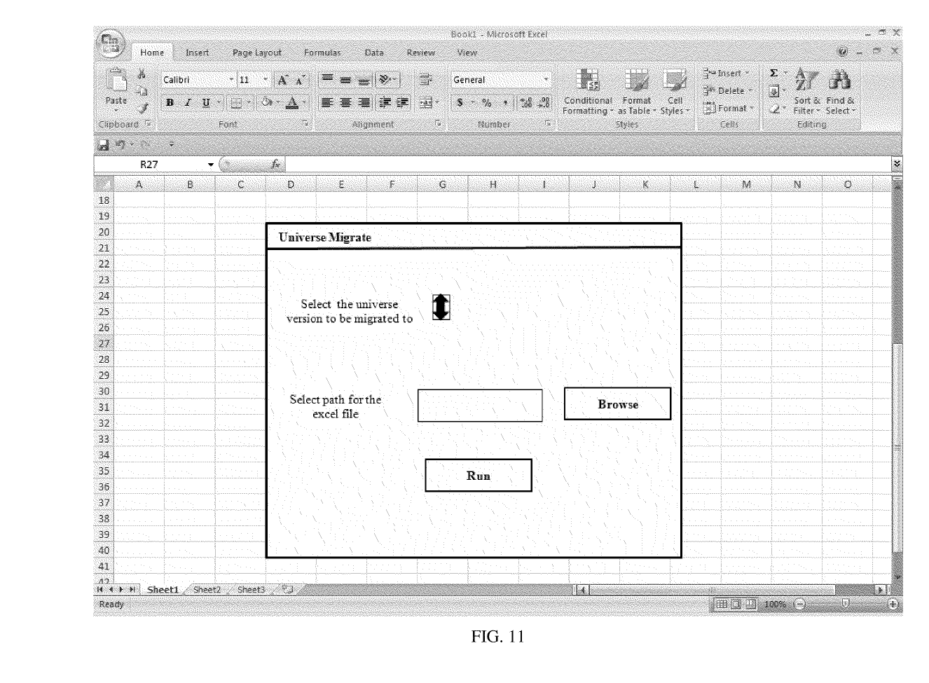

Referring to FIG. 11 which shows a screen-shot when user clicks on Migrate Universe button in the Tool, in one embodiment of the present technique.

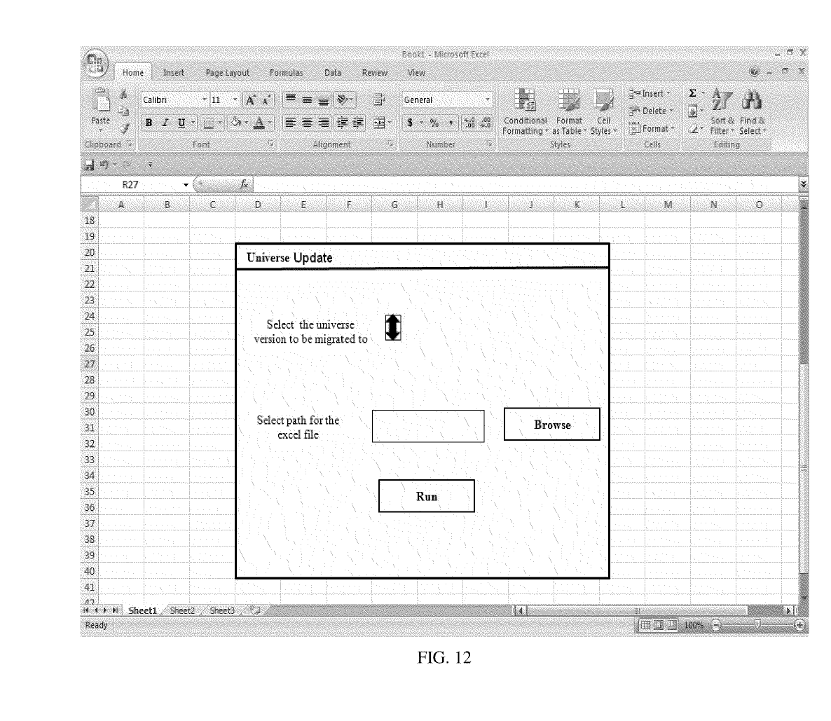

Referring to FIG. 12 which shows a screen-shot when user clicks on Update Universe button in the Tool, in one embodiment of the present technique

Thus using the Tool, user can create a universe from the design MS-Excel files which helps reduction in the coding effort of the project and also removes the problem of corruption of the universe file or link being lost. And user can easily maintains the universe as the universe can be created from the MS-Excel file and hence can be reverted to any previous version of the universe.

The advantages of the presented inventive method and thus of the Tool are: Reduction of Universe build effort, Easy maintenance of the Universe versions, and Multi user development environment as Microsoft Excel can be shared between multiple users.

The Tool is developed using the above described inventive method and using BO and Microsoft Excel.

Technologies to be used for the Tool development are Business Objects and Microsoft Excel. In Business Objects, for XiR2 it needs a CMS instance running. For lower versions it needs BO main key. Client installation on windows machine for the version needs to present. As far as Packaging, Distribution and Deployment of the Tool is concerned, this Tool will be packaged and distributed as an EAR (enterprise archive) consisting of all its classes and associated libraries.

Exemplary Computing Environment

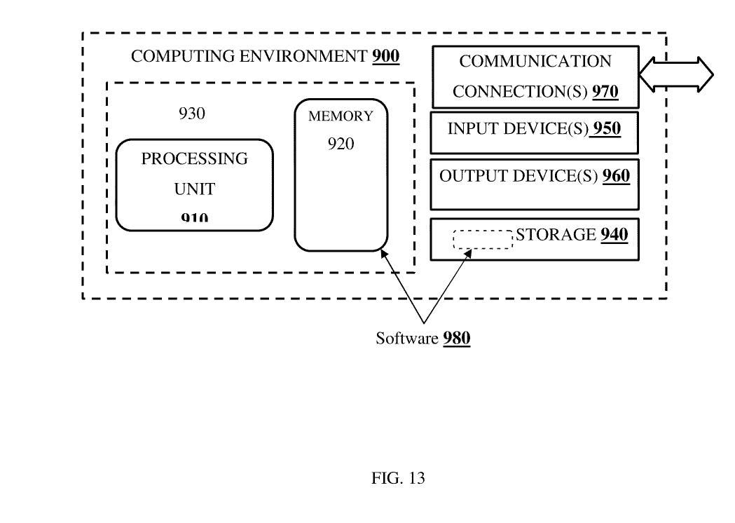

One or more of the above-described techniques may be implemented in or involve one or more computer systems. FIG. 13 illustrates a generalized example of a computing environment 900. The computing environment 900 is not intended to suggest any limitation as to scope of use or functionality of described embodiments.

With reference to FIG. 13, the computing environment 900 includes at least one processing unit 910 and memory 920. In FIG. 13, this most basic configuration 930 is included within a dashed line. The processing unit 910 executes computer-executable instructions and may be a real or a virtual processor. In a multi-processing system, multiple processing units execute computer-executable instructions to increase processing power. The memory 920 may be volatile memory (e.g., registers, cache, RAM), non-volatile memory (e.g., ROM, EEPROM, flash memory, etc.), or some combination of the two. In some embodiments, the memory 920 stores software 980 implementing described techniques.

A computing environment may have additional features. For example, the computing environment 900 includes storage 940, one or more input devices 950, one or more output devices 960, and one or more communication connections 970. An interconnection mechanism (not shown) such as a bus, controller, or network interconnects the components of the computing environment 900. Typically, operating system software (not shown) provides an operating environment for other software executing in the computing environment 900, and coordinates activities of the components of the computing environment 300.

The storage 940 may be removable or non-removable, and includes magnetic disks, magnetic tapes or cassettes, CD-ROMs, CD-RWs, DVDs, or any other medium which may be used to store information and which may be accessed within the computing environment 900. In some embodiments, the storage 940 stores instructions for the software 980.

The input device(s) 950 may be a touch input device such as a keyboard, mouse, pen, trackball, touch screen, or game controller, a voice input device, a scanning device, a digital camera, or another device that provides input to the computing environment 900. The output device(s) 960 may be a display, printer, speaker, or another device that provides output from the computing environment 300.

The communication connection(s) 970 enable communication over a communication medium to another computing entity. The communication medium conveys information such as computer-executable instructions, audio or video information, or other data in a modulated data signal. A modulated data signal is a signal that has one or more of its characteristics set or changed in such a manner as to encode information in the signal. By way of example, and not limitation, communication media include wired or wireless techniques implemented with an electrical, optical, RF, infrared, acoustic, or other carrier.

Implementations may be described in the general context of computer-readable media. Computer-readable media are any available media that may be accessed within a computing environment. By way of example, and not limitation, within the computing environment 900, computer-readable media include memory 920, storage 940, communication media, and combinations of any of the above.

Having described and illustrated the principles of our invention with reference to described embodiments, it will be recognized that the described embodiments may be modified in arrangement and detail without departing from such principles. It should be understood that the programs, processes, or methods described herein are not related or limited to any particular type of computing environment, unless indicated otherwise. Various types of general purpose or specialized computing environments may be used with or perform operations in accordance with the teachings described herein. Elements of the described embodiments shown in software may be implemented in hardware and vice versa.

In view of the many possible embodiments to which the principles of our invention may be applied, we claim as our invention all such embodiments as may come within the scope and spirit of the following claims and equivalents thereto.

While the present invention has been related in terms of the foregoing embodiments, those skilled in the art will recognize that the invention is not limited to the embodiments depicted. The present invention may be practiced with modification and alteration within the spirit and scope of the appended claims. Thus, the description is to be regarded as illustrative instead of restrictive on the present invention.

1. A method for automatically generating at least one universe using a computer system, the method comprising:
documenting a plurality of universe files in MS-Excel; and
generating the at least one universe from the documented MS-Excel files.

2. The method of claim 1, wherein documenting a plurality of universe files further comprising listing plurality of linked universes and universe connection parameters for exporting the universe to the repository.

3. The method of claim 1, wherein documenting a plurality of universe files further comprising listing a plurality of tables that are in use in the plurality of universe files and all the columns of respective tables for validating the existing of the tables and creating and establishing the tables and joins on the universe files and defining the object definition.

4. The method of claim 3, further comprising listing a plurality of joins defined for the tables for defining the joins on the universe.

5. The method of claim 2, further comprising listing contexts defined for the plurality of universe file.

6. The method of claim 2, further comprising listing classes and objects defined in the plurality of universe file for creating the classes and the objects on the universe with the respective defintions.

7. The method of claim 2, further comprising listing a plurality of conditions for creating at least one filter on the universe.

8. The method of claim 3, further comprising listing the incompatibility between the different tables and objects of the plurality of universe file.

9. The method of claim 1, wherein generating at least one universe further comprising adding universe parameters from the documented MS-Excel file onto the new universe file created.

10. The method of claim 1, wherein generating at least one universe further comprising adding the tables from the documented MS-Excel file onto the new Universe file for creating the new univerese with all the required tables.

11. The method of claim 10, further comprising adding columns to the tables from the documented MS-Excel file for adding the identified object definitions requried from the columns that are defined on the database.

12. The method of claim 10, further comprising adding joins between the tables from the documented MS-Excel file for establishing the relation between the selected tables on the universe.

13. The method of claim 9, further comprising adding contexts to the universe file for identifying different paths for reporting.

14. The method of claim 1, wherein generating at least one universe from the documented excel files further comprising adding classes to the universe file for grouping the objects that are identified under logical sections for easy understanding while creating the reports.

15. The method of claim 14, further comprising adding objects to the universe file for creating the objects for easy understanding without knowing which DB component is getting refered to.

16. The method of claim 10 and claim 15, further comprising adding incompatibility between the tables and objects from the doumented MS-Excel file for making the right use the objects.

17. The method of claim 1, wherein generating at least one universe from the documented MS-Excel files further comprising adding conditions to the universe file for identifying the filter conditions and to enable a list of values.

18. The method as recited in claim 1, further comprising updating of the generated universe.

19. A system for automatically generating at least one universe using a computer system, comprising:
means for documenting a plurality of universe files in MS-Excel; and
means for generating at least one universe from the documented MS-Excel files.

20. A computer program product comprising a computer usable medium having a computer readable program code embodied therein for automatic universe generation, the method comprising:
program codes adapted for documenting a plurality of universe files in MS-Excel; and
program codes adapted for generating at least one universe from the documented MS-Excel files.

21. The product of claim 21, further comprising program code adapted for updating of the generated universe.
